(19) United States
(12) Patent Application Publication
(10) Pub. No.: US 2016/0328348 A1
(43) Pub. Date: Nov. 10, 2016

(54) COMPUTER AND COMPUTER I/O CONTROL METHOD

(71) Applicant: HITACHI, LTD., Tokyo (JP)

(72) Inventors: Tooru IBA, Tokyo (JP); Yoshihiro TOYOHARA, Tokyo (JP); Naoki KUBOTA, Yokohama (JP); Tetsuhiro GOTOU, Tokyo (JP)

(73) Assignee: HITACHI, LTD., Tokyo (JP)

(21) Appl. No.: 15/109,844

(22) PCT Filed: Jan. 29, 2014
(86) PCT No.: PCT/JP2014/051890

§ 371 Date: Jul. 6, 2016

(51) Int. Cl. G06F 13/38; G06F 13/24; G06F 9/455; G06F 13/40

(52) U.S. Cl. CPC G06F 13/385; G06F 13/4022; G06F 13/24; G06F 9/45558

(57) ABSTRACT

This invention provides a computer that, on the basis of identifying information for virtual ports for virtual machines in logical partitions, allows per-virtual-machine access control for storage systems. Said computer, which connects to said storage systems, has the following: hardware resources including processors, physical memory, and an I/O adapter; and a first hypervisor that logically divides said hardware resources into one or more logical partitions. Upon receiving an instruction to issue an I/O command to a logical unit of a storage system from a first virtual machine in a first logical partition, the I/O adapter transmits, to said storage system, an I/O command containing first identifying information that identifies a first virtual port for the first virtual machine.

### TECHNICAL FIELD

The present invention relates to a computer and a computer I/O control method.

### BACKGROUND ART

As background art in the present technical field, there is a publication, Japanese Patent Application Publication No. 2011-181080 (Patent Literature 1). In this publication, described is “providing a channel adapter, in a data processing system in which multiple OSs run, which can be shared among the OSs only by creating an address mapping table without changing control data for carrying out input/output processing” (see Abstract).

### CITATION LIST

### Patent Literature

Patent Literature 1: Japanese Patent Application Publication No. 2011-181080

### SUMMARY OF INVENTION

### Technical Problem

For virtualizing a computer, a logical partitioning (LPAR) scheme and a virtual machine scheme are available. By the virtual machine scheme for instance, when one hypervisor runs on a computer and multiple virtual machines operate, there is a possibility that change in the load on one virtual machine or its fault or the like has an effect on another virtual machine. Then, in combination of the LPAR scheme and the virtual machine scheme for instance, if a hypervisor is run to make virtual machines operate in each of multiple logical partitions (LPARs) generated on a computer, independence of each LPAR enables it to prevent that change in the load on a virtual machine or its fault or the like in one LPAR has an effect on a virtual machine in another LPAR. Thus, there is an emerging demand to make virtual machines operate in an LPAR on a computer.

In Patent Literature 1, a channel adapter (I/O adapter) can be shared between or among multiple LPARs operating on the hypervisor. However, for example, if multiple virtual machines are generated in an LPAR, because of I/O adapter assignment on a per LPAR basis which has ever been practiced, a storage system cannot recognize which virtual machine in the LPAR accesses it and a new problem arises in which it is impossible to perform access control on a per virtual machine basis within an LPAR.

### Solution to Problem

To solve the above problem, the present invention includes hardware resources which include processors, a physical memory, and an I/O adapter; and a first hypervisor which logically divides the hardware resources into one or more logical partitions. When the I/O adapter receives an instruction to issue an input/output command to a logical unit included in a storage system from a first virtual machine included in a first logical partition, the I/O adapter sends an input/output command including first identifying information which identifies a first virtual port included in the first virtual machine to the storage system.

### Advantageous Effects of Invention

It is possible to provide a computer enabling access control on a per virtual machine basis on the storage system side, based on identifying information which identifies a virtual port included in a virtual machine in an LPAR. Problems, configurations, and advantageous effects other than described above will be apparent from the following descriptions of embodiments for carrying out the invention.

### BRIEF DESCRIPTION OF DRAWINGS

FIG. 1 is a diagram depicting a configuration of a computer system.

FIG. 2 is a diagram depicting a physical configuration of the computer system.

FIG. 3 is a diagram depicting a configuration of a computer.

FIG. 4 is a diagram representing PORT_ID management information.

FIG. 5 is a diagram representing a PORT_ID register command.

FIG. 6 is a diagram representing information on virtual ports under management of an LPAR.

FIG. 7 is a diagram representing a structure of an entry of an invoke queue.

FIG. 8 is a diagram representing a structure of an entry of a response queue.

FIG. 9 is a sequence diagram illustrating a process of generating a virtual machine.

FIG. 10 is a sequence diagram illustrating a process of issuing an input/output command from a virtual machine.

FIG. 11 is a sequence diagram illustrating a process of I/O response to a virtual machine.

FIG. 12 is a sequence diagram illustrating a process of removing a virtual port assigned to a virtual machine.

FIG. 13 is a diagram depicting a configuration of a computer system, when carrying out migration.

FIG. 14 is a sequence diagram illustrating a process of migrating a virtual machine between computers.

### DESCRIPTION OF EMBODIMENTS

In the following, embodiments will be described with reference to the drawings.

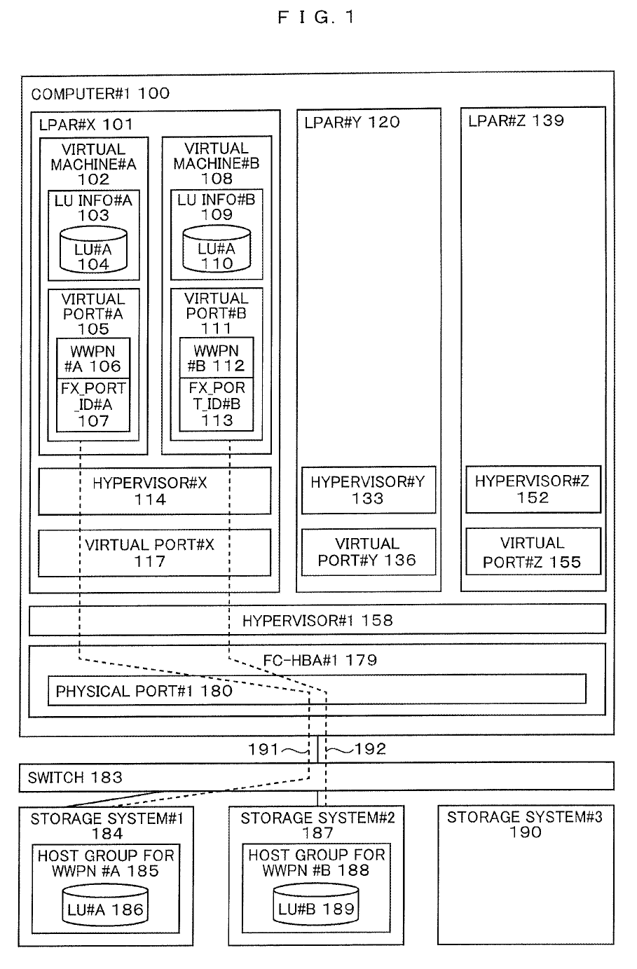

FIG. 1 is a diagram depicting a configuration of a computer system. A computer #1 100 includes FC-HBA (Fibre Channel Host Bus Adapter) #1 179 which is an I/O adapter, hypervisor #1 (first hypervisor) 158, and one or more logical partitions (LPARs: Logical Partitions) (LPAR #X 101, LPAR #Y 120, and LPAR #Z 139) The FC-HBA #1 179 includes physical port #1 180.

The one or more logical partitions (LPAR #X 101, LPAR #Y 120, and LPAR #Z 139) respectively include virtual ports (virtual port #X 117, virtual port #Y 136, and virtual port #Z 152), hypervisors (second hypervisors: hypervisor #X 114, hypervisor #Y 133, and hypervisor #Z 152), and one or more virtual machines (virtual machine #A 102, virtual machine #B 108, etc.) generated by the hypervisors (hypervisor #X 114, hypervisor #Y 133, and hypervisor #Z 152). Among two or more LPARs generated by the hypervisor #1 158, there may be one or more LPARs without an internal hypervisor.

Here, a hypervisor is a program for implementing virtualization. A hypervisor may be a virtual machine monitor or a virtualization mechanism having functionality of implementing virtualization. Resources that hardware has (hardware resources: physical CPUs, physical memories, physical I/Os, etc.) are divided by a hypervisor. LPAR refers to a logical partition to which logically divided hardware resources were assigned. Resources that hardware has (physical CPUs, physical memories, physical I/Os, etc.) are converted to abstracted resources (logical CPUs, logical memories, logical I/Os, etc.) by a hypervisor. A virtual machine refers to a logical server to which abstracted resources ware assigned.

In the present embodiment, resources that hardware has are, for example, processor #1 202, processor #2 203, main memory (physical memory) 200, FC-HBA #1 179 (I/O adapter), etc. that the computer #1 100 has. LPARs and virtual machines are not limited to an LPAR scheme and a virtual machine scheme for virtualization and may be logical servers which are implemented by another virtualization scheme.

A virtualization structure in the present embodiment has two stages; as described above, LPARs are generated by the first hypervisor (first stage) and virtual machines are generated by the second hypervisors (second stage) included within the LPARs respectively. However, the present invention can also be applied to even a virtualization structure having three or more stages; for example, third hypervisors (third stage) are further included within the virtual machines respectively.

The hypervisor #1 158 retains and manages RIDs (Resource IDs) which are identification information for identifying the respective LPARs. For example, the hypervisor #1 158 correlates X, Y, and Z, as the RIDs of LPAR #X 101, LPAR #Y 120, and LPAR #Z 139, to each LPAR respectively and retains and manages this correlation information. Each LPAR retains and manages its RID.

The computer #1 100 connects with storage system #1 184, storage system #2 187, and storage system #3 190 respectively via the physical port #1 180 of the FC-HBA #1 179 and a switch 183. The switch 183 is, for example, a FC (Fibre Channel) Switch.

LPAR #X 101, LPAR #Y 120, and LPAR #Z 139 share the physical port #1 180 of the FC-HBA #1 179. The hypervisor #1 158 generates virtual ports (virtual port #X 117, virtual port #Y 136, and virtual port #Z 155) which each correspond to the physical port #1 180 and assigns each virtual port to each of the LPAR #X 101, LPAR #Y 120, and LPAR #Z 139.

In the following context describing an embodiment, description focuses on the LPAR #X 101 among these LPARs. The LPAR #Y 120 and LPAR #Z 139 are configured the same as for the LPAR #X 101 and their description is dispensed with.

A hypervisor #X 114 in the LPAR #X 101 generates a virtual machine #A 102 and a virtual machine #B 108. Here, the LPAR #X 101 is a logical partition to which logically divided hardware resources were assigned, as described previously, and a virtual port #X 117 is a port which is identified by its specific identifying information WWPN #X 118 and N_PORT_ID #X 119; thus, the hypervisor #X 114 can recognize the virtual port #X 117 as if it was the physical port.

Accordingly, as the hypervisor #1 158 generates the virtual port #X 117, virtual port #Y 136, and virtual port #Z 155 as virtual ports which each correspond to the physical port #1 180 and assigns them to the LPAR #X 101, LPAR #Y 120, and LPAR #Z 139, the hypervisor #X 114 in the LPAR #X 101 can do so. That is, the hypervisor #X 114 in the LPAR #X 101 generates a virtual port #A 105 and a virtual port #B 111 which each correspond to the virtual port #X 117 and assigns them to the virtual machine #A 102 and the virtual machine #B 108 respectively. The virtual machine #A 102 and the virtual machine #B 108 share the virtual port #X 117.

The virtual ports (virtual port #X 117, virtual port #A 105, and virtual port #B 111) are each assigned WWPN (World Wide Port Number) (WWPN #X 118, WWPN #A 106, and WWPN #B 112) and PORT_ID (N_PORT_ID #A 119, FX_PORT_ID #A 107, FX_PORT_ID #B 113) as their specific identifying information which identifies a virtual port and retain the identifying information assigned thereto.

Each storage system (storage system #1 184, storage system #2 187, and storage system #3 190) includes one or more storage devices, logical units (LUs) which are storage areas in the one or more storage devices, and a controller which controls the storage system. A storage system assigns an LU to a physical port (e.g., physical port #1 180) of FC-HBA (e.g., FC-HBA #1 179) via which it is connected to the computer or WWPN (or FX_PORT_ID), which is identifying information, of a virtual port (e.g., virtual port #X 117, virtual port #A 105, etc.) which corresponds to the physical port.

A storage system permits access from a physical port or virtual port to an LU assigned to the physical port or WWPN or (FX_PORT_ID) of the virtual port, but does not permit access to an LU not assigned thereto. A mapping relation between WWPN and LU is referred to as a host group.

A virtual machine in the LPAR is assigned to a virtual port having a WWPN and can control one or more LUs which are accessible to WWPN of one or more virtual machines according to host group setting in a storage system. Therefore, access from a virtual machine in the LPAR to an LU can be controlled between virtual machines (including exclusive access control).

In the present embodiment, a storage system #1 184 sets a host group 185 for WWPN #A and assigns an LU #A 186 to the host group 185. Therefore, a virtual machine #A 102 can get access to the LU #A 186 via the virtual port #A 105 which is identified by WWPN #A 106. This access path is represented by a path 191. The virtual machine #A 102 has LU information #A 103 by which LU #A 104 (which corresponds to the LU #A 186) is recognized.

If the host group 185 for WWPN #A is only assigned to the LU #A 186, access from other virtual machines (such as, e.g., virtual machine #B 108) present in the same or a different LPAR and from an LPAR to the LU #A 186 is disabled. In this case, because other WWPNs than the WWPN #A are not set for the host group 185 assigned to the LU #A 186, the storage system #1 184 prohibits access via a physical port or virtual port having a WWPN other than the WWPN #A to the LU #A 186.

Also for storage system #2 187 and storage system #3 190, access control according host group setting for WWPN can be implemented, as is the case for the storage system #1 184. For example, the storage system #2 187 sets a host group 188 for WWPN #B and assigns an LU #B 189 to the host group 188, so that a virtual machine #B 108 can get access to the LU #B 189 via a virtual port #B 111 which is identified by WWPN #B 112. This access path is represented by a path 192. The virtual machine #B 108 has LU information #B 109 by which LU #B 110 (which corresponds to the LU #B 189) is recognized.

According to the configuration described above, the virtual machine #A 102 can access the LU #A 186, but cannot access the LU #B 189. On the other hand, the virtual machine #B 108 present in the same LPAR #X 101 that includes the virtual machine #A 102 cannot access the LU #A 186, but can access the LU #B 189. That is, the computer system can implement exclusive access control on a per virtual machine basis in addition to a per computer basis and a per LPAR basis. Likewise, access control can also be implemented by setting zoning in the switch (FC Switch) 183 according to the WWPN of a virtual port that a virtual machine has.

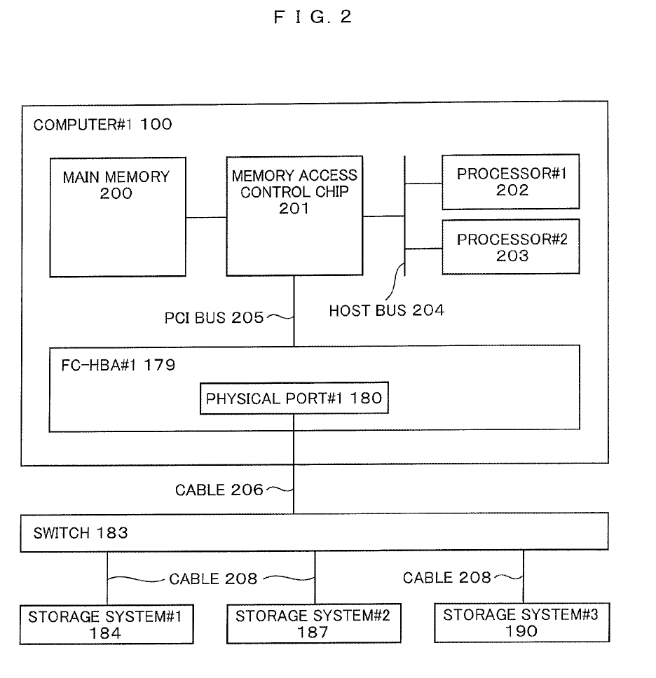

FIG. 2 is a diagram depicting a physical configuration of the computer system. The computer #1 100 includes a processor #1 202, a processor #2 203, a main memory (physical memory) 200, a memory access control chip 201, FC-HBA #1 179, a host bus 204 which connects the memory access control chip 201, processor #1 202, processor #2 203, and main memory 200, and a PCI bus 205 which connects the memory access control chip 201 and FC-HBA #1 179.

The storage system #1 184, storage system #2 187, and storage system #3 190 connect with the physical port #1 180 of the FC-HBA #1 179 via a cable 206, a switch 183, and cables 208.

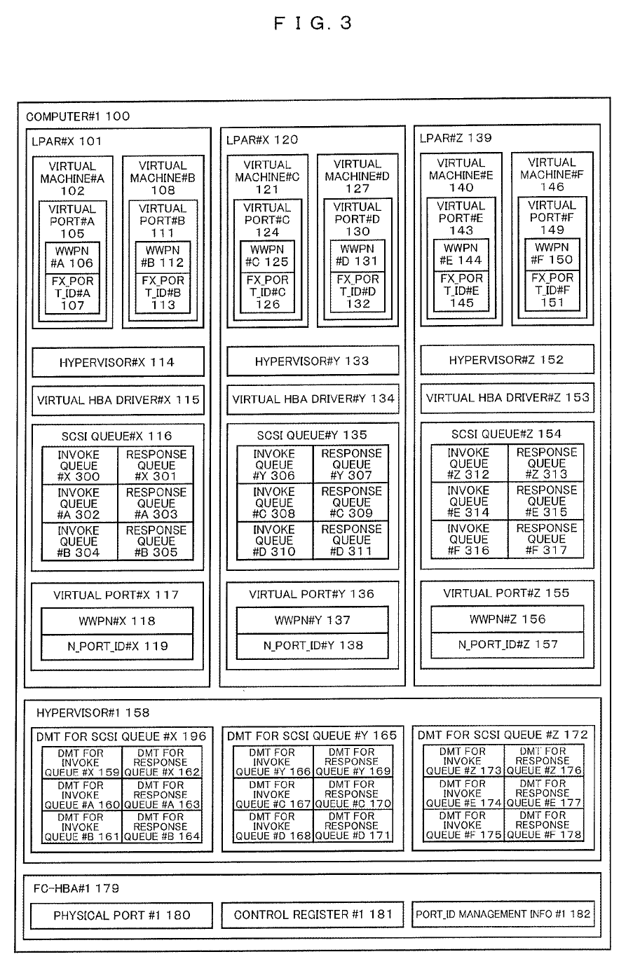

FIG. 3 is a diagram depicting a configuration of the computer #1 100. Hereinafter, descriptions are provided about the LPAR #X 101. The LPAR #Y 120 and LPAR #Z 139 are configured the same as for the LPAR #X 101, as depicted in FIG. 3, and their description is dispensed with.

The LPAR #X 101 further includes a virtual HBA driver (virtual driver) #X 115 and a SCSI queue #X 116 in addition to previously described components such as the virtual machine #A 102, virtual machine #B 108, hypervisor #X 114, and virtual port #X 117.

The SCSI queue #X 116 makes management of I/Os from the virtual machine #A 102, virtual machine #B 108, and LPAR #X 101. In the SCSI queue #X 116, there are invoke queues which make management of information on I/Os (input/output commands) which are issued to a storage system and response queues which make management of information on I/Os (input/output results) which are returned from a storage system.

The SCSI queue #X 116 includes an invoke queue #X 300, invoke queue #A 302, and invoke queue #B 304 as invoke queues which are dedicated respectively for the LPAR #X 101, virtual machine #A 102, and virtual machine #B 108. Likewise, the SCSI queue #X 116 includes a response queue #X 301, response queue #A 303, and response queue #B 305 as response queues which are dedicated respectively for the LPAR #X 101, virtual machine #A 102, and virtual machine #B 108.

The hypervisor #1 158 includes a DMT 196 for SCSI queue #X which is address mapping information (Direct memory access (DMA) Mapping Table abbreviated to DMT) dedicated for the SCSI queue #X 116. The DMT 196 for SCSI queue #X is address mapping information for converting a virtual memory address in the SCSI queue #X present in the LPAR #X 101 to a physical memory address in the main memory 200. The hypervisor #1 158 uses the DMT 196 for SCSI queue #X to make address conversion when executing a DMA transfer.

The addresses of I/Os queued in the SCSI queue #X 116 present in the LPAR #X 101 are virtual memory addresses and it is needed to convert a virtual memory address to a physical memory address to issue an I/O (input/output command) via the physical port #1 180 of the FC-HBA #1 179. The DMT 196 for SCSI queue #X includes sets of address mapping information (DMTs) 159 to 164 which are provided respectively for the invoke queue #X 300, response queue #X 301, invoke queue #A 302, response queue #A 303, invoke queue #B 304, and response queue #B 305.

The invoke queues 300, 302, 304 and the response queues 301, 303, 305 in the SCSI queue #X 116 each include one or more entries (entry 1, entry 2, . . . entry N) and virtual addresses are assigned to these one or more entries. The DMT 196 for SCSI queue #X makes management of physical addresses mapped to the virtual addresses assigned to the one or more entries. The hypervisor #1 158 refers to the DMT 196 for SCSI queue #X, converts a virtual address which addresses a location in an invoke queue or a response queue present in the SCSI queue #X 116 under control of the LPAR #X 101 to a physical address mapped to the virtual address, and sends the physical address to the FC-HBA #1 179.

The FC-HBA #1 179 includes a physical port #1 180, a control register #1 181, and PORT_ID management information #1 182 as information for identifying an LPAR/virtual machine which is the destination to send an I/O response from a storage system.

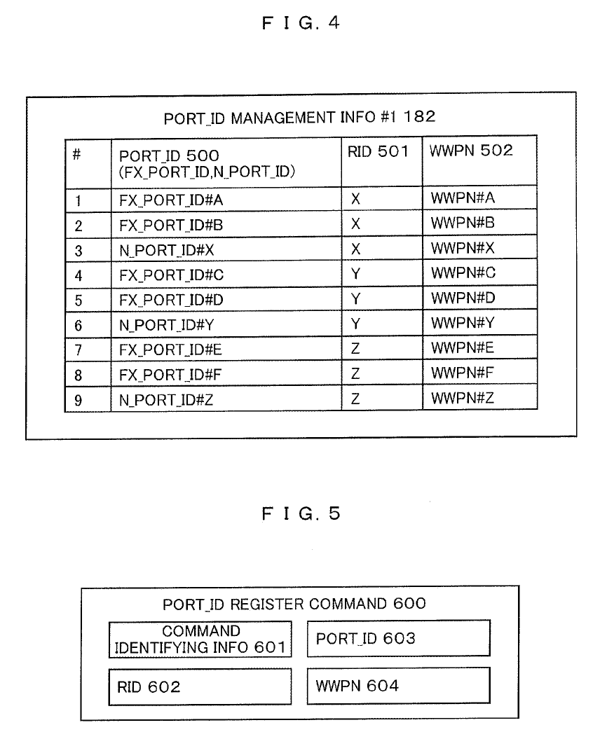

FIG. 4 is a diagram representing PORT_ID management information #1 182 which is managed by the FC-HBA #1 179. The table of PORT_ID management information #1 182 holds correlations among PORT_ID 500, RID 501, and WWPN 502. The fields of PORT_ID 500 and WWPN 502 hold N_PORT_ID or FX_PORT_ID and WWPN respectively.

The field of RID 501 holds RID which is information identifying an LPAR including a virtual port which is identified by PORT_ID 500 and WWPN 502. According to the PORT_ID management information #1 182, the FC-HBA #1 179 determines, from WWPN 502, an LPAR which is the destination to send an I/O response.

As another embodiment of the PORT_ID management information #1 182, the information table may hold mapping relations between two items of PORT_ID 500 and RID 501 or may hold mapping relations between two items of RID 501 and WWPN 502.

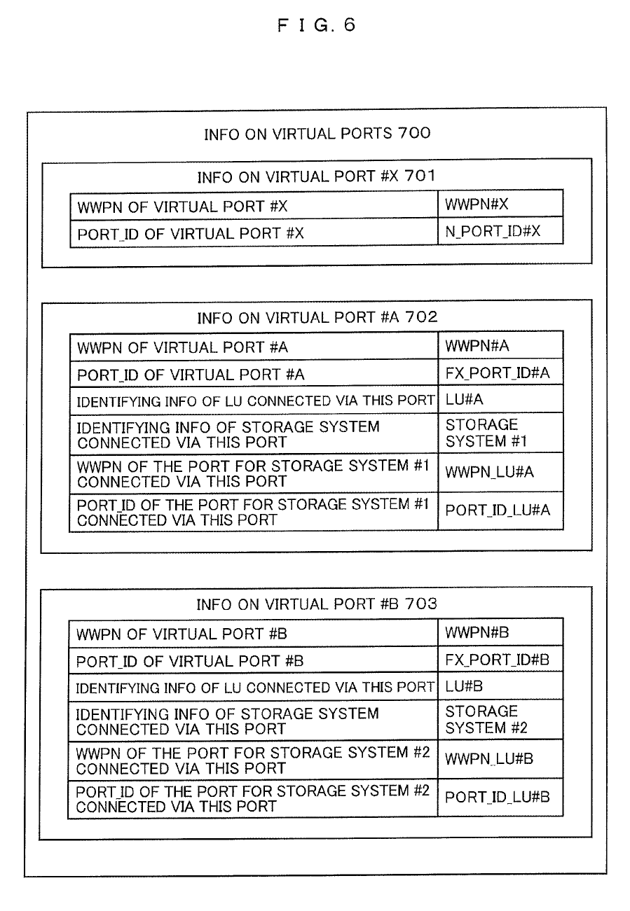

FIG. 5 is a diagram representing a PORT_ID register command 600 which is issued from a virtual HBA driver #X 115 to the hypervisor #1 158 and the FC-HBA #1 179. The PORT_ID register command 600 includes command identifying information 601 which designates that the command is a command to register a PORT_ID, the PORT_ID (N_PORT_ID or FX_PORT_ID) 603 and WWPN 604 of a virtual port to be registered, and the RID 602 of an LPAR in which the virtual port to be registered resides.

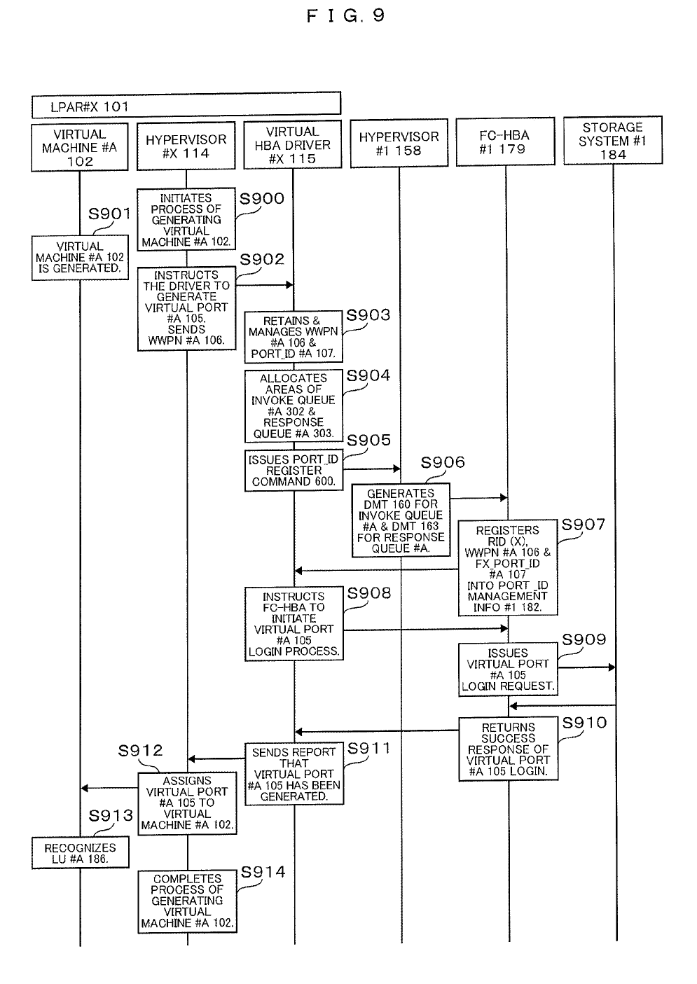

The virtual HBA driver #X 115 issues a PORT_ID register command 600 to the hypervisor #1 158 and the FC-HBA #1 179. Then, information on a virtual port (RID 602, PORT_ID 603, and WWPN 604) is added to PORT_ID registration information (in the fields of RID 501, PORT_ID 500, and WWPN 502 respectively). Detail on this registration process will be described with FIG. 9.

Likewise, a command to delete PORT_ID includes command identifying information 601, RID 602, PORT_ID 603, and WWPN 604, as is the case for the PORT_ID register command. In the case of the command to delete PORT_ID, the command identifying information 601 designates that the command is a command to delete a PORT_ID.

FIG. 6 is a diagram representing information 700 on virtual ports under management of the LPAR #X 101. The LPAR #X 101 retains and manages information 701 on virtual port #X, information 702 on virtual port #A, and information 703 on virtual port #B, for example, at the virtual HBA driver #X 115.

Here, the information 701 on virtual port #X is WWPN #X 118, N_PORT_ID #X 119, etc. which are identifying information of the virtual port #X 117. The information 702 on virtual port #A is WWPN #A 106 and FX_PORT_ID #A 107 which are identifying information of the virtual port #A 105, identifying information (LU #A) of an LU connected via this port, identifying information (storage system #1) of a storage system connected via this port, WWPN (assumed as WWPN_LU #A in the present embodiment) and PORT_ID (assumed as PORT_ID_LU #A in the present embodiment) of the port for the storage system #1 connected via this port, etc.

In the information 702 on virtual port #A, the identifying information of an LU connected via this port is information identifying an LU to which the virtual machine #A can get access, that is, information identifying the LU #A that is assigned to the host group 185 for WWPN #A. The port for the storage system #1 connected via this port is a physical port or virtual port belonging to the storage system #1 184 that sets up the host group 185 for WWPN #A and the port that the virtual machine #A 102 uses when accessing the LU #A 186.

Likewise, the information 703 on virtual port #B is WWPN #B 112 and FX_PORT_ID #B 113 which are identifying information of the virtual port #B 111, identifying information (LU #B) of an LU connected via this port, identifying information (storage system #2) of a storage system connected via this port, WWPN (assumed as WWPN_LU #B in the present embodiment) and PORT_ID (assumed as PORT_ID_LU #B in the present embodiment) of the port for the storage system #2 connected via this port, etc.

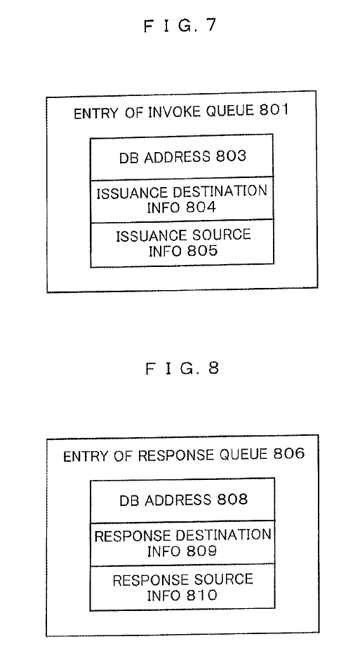

FIG. 7 is a diagram representing a structure of an entry of an invoke queue. The invoke queue #X 300, invoke queue #A 302, and invoke queue #B 304 in the SCSI queue #X 116 each include one or more entries (entry 1, entry 2, . . . entry N) and a structure of one entry 801 among them is presented here.

The entry 801 includes a DB (data buffer) address 803, issuance destination information 804 (e.g., PORT_ID, WWPN) that identifies a port (physical port or virtual port) which is the destination to which an input/output command should be issued, and issuance source information 805 (e.g., PORT_ID, WWPN) that identifies a virtual port which is the source from which the input/output command should be issued. The DB address 803 is a physical memory address that addresses a storage area (data buffer) allocated for the entry 801 among the storage areas of the main memory (physical memory) 200.

FIG. 8 is a diagram representing a structure of an entry of a response queue. The response queue #X 301, response queue #A 303, and response queue #B 305 in the SCSI queue #X 116 each include one or more entries (entry 1, entry 2, . . . entry N) and a structure of one entry 806 among them is presented here.

The entry 806 includes a DB address 808, response destination information 809 (e.g., PORT_ID, WWPN) that identifies a virtual port which is the destination to which an I/O response should be sent, and response source information 810 (e.g., PORT_ID, WWPN) that identifies a port (physical port or virtual port) which is the source from which the I/O response should be sent. The DB address 808 is a physical memory address that addresses a storage area (data buffer) allocated for the entry 806 among the storage areas of the main memory (physical memory) 200. The virtual HBA driver #X 115 and the FC-HBA #1 179 identify an LPAR and a virtual port according to the response destination information 809. Each LPAR makes management of a SCSI queue having plural entries 801, 806 on a per virtual port basis.

FIG. 9 is a sequence diagram illustrating a process of generating a virtual machine. By way of example, a process of generating a virtual machine #A 102 is described below.

The hypervisor #X 114 initiates the process of generating a virtual machine #A 102 (S900). The generating process may be initiated, for example, triggered by an instruction issued by a user or administrator of the computer #1 100 or the LPAR #X 101 or an instruction issued from an administrative computer which makes management of the computer #1 100 or the LPAR #X 101.

The hypervisor #X 114 generates a virtual machine #A 102 (S901). Here, the hypervisor #X 114 converts logically divided hardware resources (the main memory 200, processor #1 202, processor #2 203, and the physical port #1 180 of the FC-HBA #1 179) assigned to the LPAR #X 101 to abstracted resources (logical CPU, logical memory, and logical I/O) and generates the virtual machine #A 102 to which the abstracted resources were assigned.

The hypervisor #X 114 generates a virtual port #A 105 and instructs the virtual HBA driver #X 115 to generate a virtual port #A 105. At the same time, the hypervisor #X 114 sends information of WWPN #A 106 to the virtual HBA driver #X 115 (S902). This WWPN #A 106 may be generated by a method in which the hypervisor #X 114 or the like generates it, based on predefined information, a method in which it is generated based on input from the user or administrator of the computer #1 100 or the LPAR #X 101, or any other method.

The virtual HBA driver #X 115 assigns FX_PORT_ID #A 107 to the received WWPN #A 106. The virtual HBA driver #X 115 retains and manages the WWPN #A 106 and FX_PORT_ID #A 107 as information 702 on virtual port #A (S903).

The virtual HBA driver #X 115 allocates areas of the invoke queue #A 302 and the response queue #A 303 to the virtual port #A 105 (S904). The virtual HBA driver #X 115 issues a PORT_ID register command 600 for the virtual port #A 105 to the hypervisor #1 158 (S905).

The PORT_ID register command 600 includes the WWPN #A 106 and FX_PORT_ID #A 107 of the virtual port #A 105 to be registered and the RID (RID=X) of the LPAR #X 101 in which the virtual port #A 105 resides. For example, the virtual HBA driver #X 115 generates the PORT_ID register command 600, referring to RID and information 702 on virtual port #A under management of the LPAR #X 101.

The hypervisor #1 158 receives the PORT_ID register command 600 and generates address mapping information (DMTs) 160, 163 for the invoke queue #A 302 and the response queue #A 303 (S906). Upon generating the DMT 160 for the invoke queue #A and the DMT 163 for the response queue #A, the hypervisor #1 158 sends the PORT_ID register command 600 to the FC-HBA #1 179.

Upon receiving the PORT_ID register command 600, the FC-HBA #1 179 refers to the PORT_ID register command 600 and correlates and registers FX_PORT_ID #A 107, RID (RID=X), and WWPN #A 106 relevant to the LPAR #X 101 into the fields of PORT_ID 500, RID 501, and WWPN 502 of the table of PORT_ID management information #1 182 (S907). When the registration is complete, the FC-HBA #1 179 sends a registration complete response to the PORT_ID register command 600 to the virtual HBA driver #X 115.

The virtual HBA driver #X 115 instructs the FC-HBA #1 179 to initiate a virtual port #A 105 login process to the storage system #1 184 (S908).

According to the above instruction (S908), the FC-HBA #1 179 issues a virtual port #A 105 login request to the storage system #1 184 (S909). Upon receiving the login request, the storage system #1 184 executes the virtual port #A 105 login process, based on the WWPN #A 106.

After receiving a login response from the storage system #1 184, the FC-HBA #1 179 returns a login success response to the virtual HBA driver #X 115 (S910). The virtual HBA driver #X 115 sends a report that the virtual port #A 105 has been generated to the hypervisor #X 114 (S911).

The hypervisor #X 114 receives the report that the virtual port #A 105 has been generated and assigns the virtual port #A 105 to the virtual machine #A 102 (S912). The virtual machine #A 102 recognizes the LU #A 186 of the storage system #1 184 (S913). The hypervisor #X 114 completes the process of generating a virtual machine #A 102 (S914).

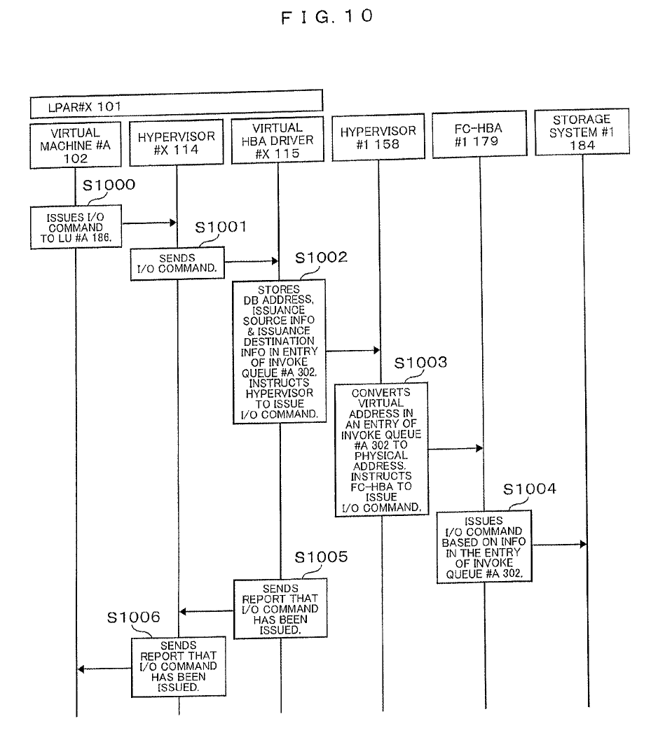

FIG. 10 is a sequence diagram illustrating a process of issuing an input/output command (I/O request) from a virtual machine. By way of example, a process of issuing an input/output command from a virtual machine #A 102 to an LU #A 186 is described below.

The virtual machine #A 102 issues an input/output command to the LU #A 186 of the storage system #1 184 from the virtual port #A 105 (S1000). The issued input/output command includes information identifying the storage system #1 and LU #A 186 which are the destination to which the input/output command should be issued, the WWPN #A 106 and FX_PORT_ID #A 107 of the virtual port #A 105 which is the source from which the input/output command should be issued, and transmission data which is issued. The transmission data includes, e.g., a command to read from or a command to write to the LU #A 186.

The hypervisor #X 114 receives the issued input/output command and sends the input/output command to the virtual HBA driver #X 115 (S1001).

The virtual HBA driver #X 115 receives the input/output command, stores the transmission data included in the input/output command into a data buffer of the main memory 200, and acquires a DB address which addresses the data buffer in which the transmission data has been stored. Based on the input/output command, the virtual HBA driver #X 115 also registers (stores) WWPN_LU #A and PORT_ID_LU #A that identity a port for the storage system #1 184, which is the destination to which the input/out command should be issued, WWPN #A 106 and FX_PORT_ID #A 107 of the virtual port #A 105 which is the source from which the input/out command should be issued, and the acquired DB address into the fields of issuance destination information 804, issuance source information 805, and DB address 803 of an entry 801 of an invoke queue #A 302, respectively.

Here, WWPN #A and PORT_ID_LU #A are, for example, retrieved from information 702 on virtual port #A, based on information identifying the storage system #1 184 and the LU #A 186 included in the input/output command.

The virtual HBA driver #X 115 instructs the hypervisor #1 158 to issue an input/output command (S1002). In this instruction to issue an input/output command, the virtual address of the entry 801 of the invoke queue #A 302 is included.

The hypervisor #1 158 receives the instruction to issue an input/output command and converts the virtual address of the entry 801 of the invoke queue #A 302 included in the instruction to issue an input/output command to a physical address, referring to the DMT 160 for the invoke queue #A. The hypervisor #1 158 also instructs the FC-HBA #1 179 to issue an input/output command (S1003). In this instruction to issue an input/output command, the physical address after the conversion, i.e., the physical address of the entry of the invoke queue #A 302 is included. As a way of making the instruction to issue an input/output command, for example, the hypervisor #1 158 writes the instruction to issue an input/output command including the physical address after the conversion into the control register #1 181.

The FC-HBA #1 179 receives the instruction to issue an input/output command, reads information in the entry 801 of the invoke queue #A 302 from the physical address after the conversion at step S1003, and acquires the DB address 803, issuance destination information 804, and issuance source information 805. Here, as a way of receiving the instruction to issue an input/output command, for example, the FC-HBA #1 179 refers to the control register #1 181 and retrieves the instruction to issue an input/output command including the physical address after the conversion.

The FC-HBA #1 179 retrieves the transmission data from a data buffer addressed by the DB address 803 and sends an input/output command including the retrieved transmission data, issuance destination information 804, and issuance source information 805 to the storage system #1 184 (S1004).

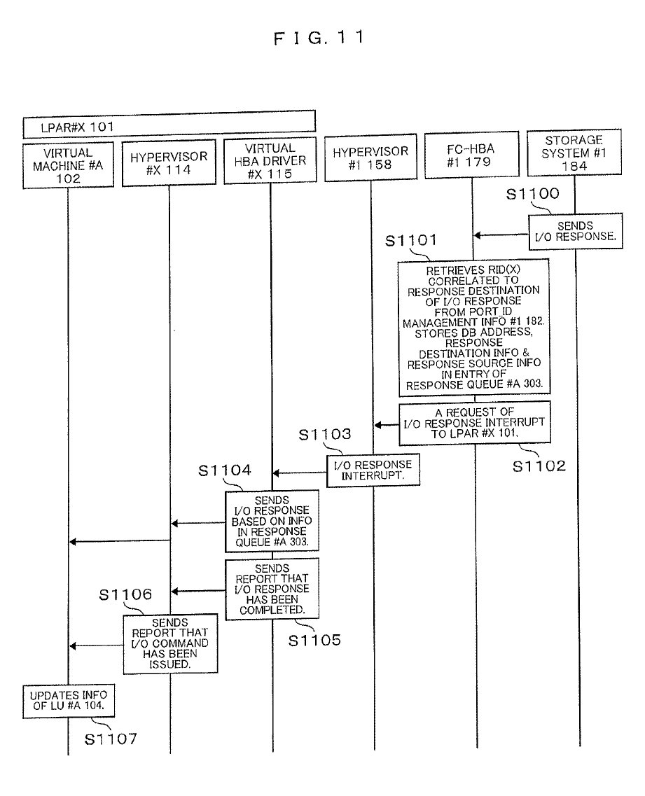

The storage system #1 184 executes the input/output command it received with respect to the LU #A 186 and sends an I/O response to the virtual machine #A 102 as the destination to send a response of input/output result. Detail will be described with FIG. 11.

The virtual HBA driver #X 115 sends a report (notification) that the input/output command has been issued to the hypervisor #X 114 (S1005). The hypervisor #X 114 sends a report that the input/output command has been issued to the virtual machine #A 102 (S1006).

FIG. 11 is a sequence diagram illustrating a process of I/O response to a virtual machine. By way of example, a process of I/O response (a response of input/output result to an input/output command) from the storage system #1 184 to the virtual machine #A 102 is described below.

The storage system #1 184 sends an I/O response to the FC-HBA #1 179 (S1100). In the I/O response, included are the following: input/output result to an input/output command, WWPN #A 106 and FX_PORT_ID #A 107 identifying a virtual port #A 105 of the virtual machine #A 102 which is the destination to which the response should be sent, and WWPN_LU #A and PORT_ID_LU #A identifying a port of the storage system #1 184 which is the source from which the response should be sent. The storage system #1 184, for example, refers to an input/output command received by the storage system #1 184, acquires WWPN #A 106 and FX_PORT_ID #A 107 identifying a virtual port #A 105 which is the destination to which the response should be sent, and generates an I/O response.

The FC-HBA #1 179 receives the I/O response, acquires WWPN #A 106 and FX_PORT_ID #A 107 identifying a virtual port #A 105 which is the destination to which the response should be sent, refers to the PORT_ID management information #1 182, and retrieves RID 501 correlated to WWPN #A 106 and FX_PORT_ID #A 107.

In this case, it retrieves “X” as RID 501 correlated to “WWPN #A” and “FX_PORT_ID #A” from the PORT_ID management information #1 182. According to the PORT_ID management information #1 182, the FC-HBA #1 179 can identify an LPAR #X 101 in which the virtual port #A 105 which is identified by WWPN #A 106 and FX_PORT_ID #A 107 resides. Thus, the FC-HBA #1 179 can send the hypervisor #1 158 a request of I/O response interrupt to the LPAR #X 101 at step S1102, while it can send the I/O response to the virtual machine in the LPAR.

The FC-HBA #1 179 also stores the input/output result included in the I/O response into a data buffer of the main memory 200 and acquires a DB address which addresses the data buffer in which the input/output result has been stored.

Based on the I/O response, the FC-HBA #1 179 registers (stores) WWPN #A 106 and FX_PORT_ID #A 107 of the virtual port #A 105 which is the destination to which the I/O response should be sent, WWPN_LU #A and PORT_ID_LU #A that identity a port for the storage system #1 184, which is the source from which the I/O response should be sent, and the acquired DB address into the fields of response destination information 809, response source information 810, and DB address 808 of an entry 806 of a response queue #A 303, respectively (S1101). The FC-HBA #1 179 writes an instruction for the I/O response including the physical address of the entry of the response queue #A 303 into the control register #1 181.

The FC-HBA #1 179 also sends the hypervisor #1 158 a request of I/O response interrupt to the LPAR #X 101 that is identified by “X” which is RID 501 retrieved from the PORT_ID management information #1 182 (S1102).

The hypervisor #1 158 receives the request of I/O response interrupt, refers to the control register #1 181, and retrieves the instruction for the I/O response including the physical address of the entry 806 of the response queue #A 303. The hypervisor #1 158 refers to the DMT 163 for response queue #A, converts the physical address of the entry of the response queue #A 303 to a virtual address, and executes an I/O response interrupt to the virtual HBA driver #X 115 in the LPAR #X 101 (S1103). In this I/O response interrupt, the virtual address after the conversion, i.e., the virtual address of the entry 806 of the response queue #A 303 is included.

The virtual HBA driver #X 115 receives the I/O response interrupt, acquires the virtual address of the entry 806 of the response queue #A 303, refers to the entry 806 of the response queue #A 303 from the acquired virtual address, and retrieves the DB address 808, response destination information 809, and response source information 810. The virtual HBA driver #X 115 also retrieves the input/output result from a data buffer addressed by the retrieved DB address. The virtual HBA driver #X 115 sends the hypervisor #X 114 the I/O response including the response destination information 809, response source information 810, and the input/output result (S1104). The hypervisor #X 114 receives the I/O response and sends it to the virtual port #A 105 which is identified by WWPN #A 106 and FX_PORT_ID #A 107 which the response destination information 809 designates.

The virtual HBA driver #X 115 sends a notification (report) that the I/O response process has been completed to the hypervisor #X 114 (S1105). The hypervisor #X 114 sends a notification that the I/O response process has been completed to the virtual machine #A 102 (S1106). The virtual machine #A 102 updates information of LU #A 104 (corresponding to LU #A 186) (S1107). The steps S1105 to S1107 may be skipped.

According to the present embodiment, it is possible to provide a computer in which access control on a per virtual machine in an LPAR can be implemented by assigning an I/O adapter (virtual port) having its specific identifying information (WWPN, PORT_ID) to a virtual machine in an LPAR, which leads to improvement in the reliability and security of a computer system.

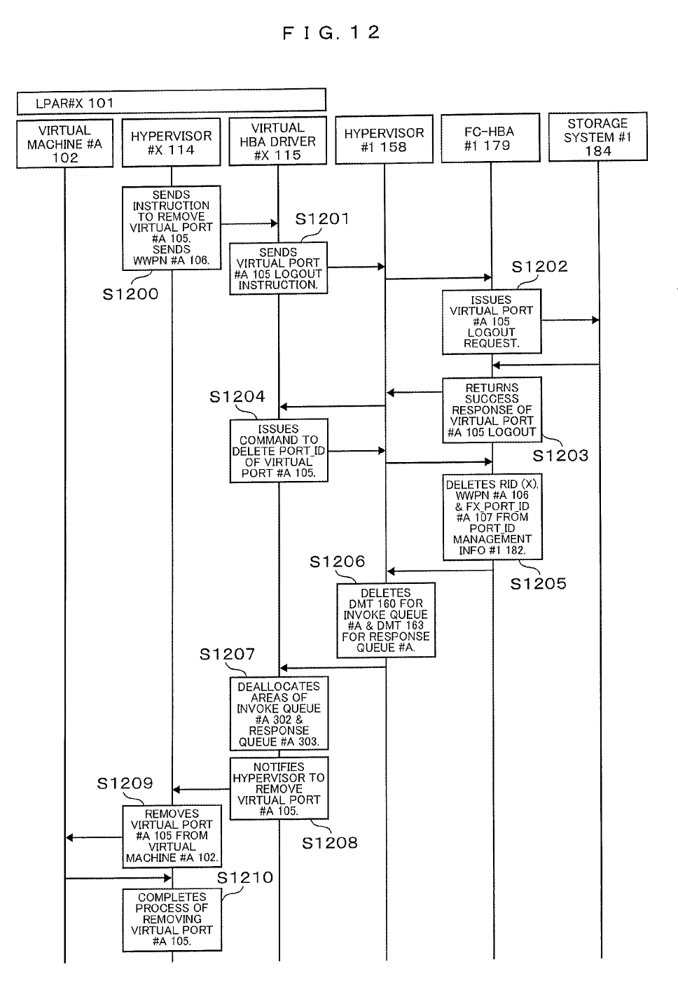

FIG. 12 is a sequence of a process of removing a virtual port assigned to a virtual machine. By way of example, a process of removing a virtual port #A 105 of a virtual machine #A 102 is described below.

The hypervisor #X 114 issues an instruction to remove the virtual port #A 105 to the virtual HBA driver #X 115. At the same time, the hypervisor #X 114 sends WWPN #A 106 as information designating the virtual port #A 105 to be removed to the virtual HBA driver #X 115 (S1200).

Upon receiving the instruction to remove the virtual port #A 105 and information of WWPN #A 106, the virtual HBA driver #X 115 sends a virtual port #A 105 logout instruction which will be given to the storage system #1 184 via the hypervisor #1 158 to the FC-HBA #1 179 (S1201). In the logout instruction, the received WWPN #A 106 is included.

Upon receiving the logout instruction, the FC-HBA #1 179 issues a virtual port #A 105 logout request to the storage system #1 184 (S1202). The virtual port #A 105 logout request includes WWPN #A 106. Upon receiving the logout request, the storage system #1 184 executes a virtual port #A 105 logout process, based on WWPN #A 106.

After receiving a logout response from the storage system #1 184, the FC-HBA #1 179 sends a notification (report) of success response of virtual port #A 105 logout via the hypervisor #1 158 to the virtual HBA driver #X 115 (S1203).

The virtual HBA driver #X 115 issues a command to delete the PORT_ID of the virtual port #A 105 via the hypervisor #1 158 to the FC-HBA #1 179 (S1204). The command to delete the PORT_ID includes WWPN #A 106 and FX_PORT_ID #A 107 of the virtual port #A 105 to be removed and RID (RID=X) of an LPAR #X 101 in which the virtual port #A 105 resides. For example, the virtual HBA driver #X 115 may generate the command to delete the PORT_ID, referring to RID and information 702 on virtual port #A under management of the LPAR #X 101.

Upon receiving the command to delete the PORT_ID, the FC-HBA #1 179 refers to the command to delete the PORT_ID and deletes information contained in the fields of PORT_ID 500 (FX_PORT_ID #A 107), RID 501 (RID=X), and WWPN 502 (WWPN #A 106) from the table of the PORT_ID management information #1 182 (S1205).

The hypervisor #1 158 deletes the DMT 160 for invoke queue #A and the DMT 163 for response queue #A (S1206). The virtual HBA driver #X 115 deallocates the areas used for the invoke queue #A 302 and the response queue #A 303 (S1207). The virtual HBA driver #X 115 notifies the hypervisor #X 114 to remove the virtual port #A 105 (S1208).

The hypervisor #X 114 removes the virtual port #A 105 from the virtual machine #A 102 (S1209). The hypervisor #X 114 completes the process of removing the virtual port #A 105 (S1210)

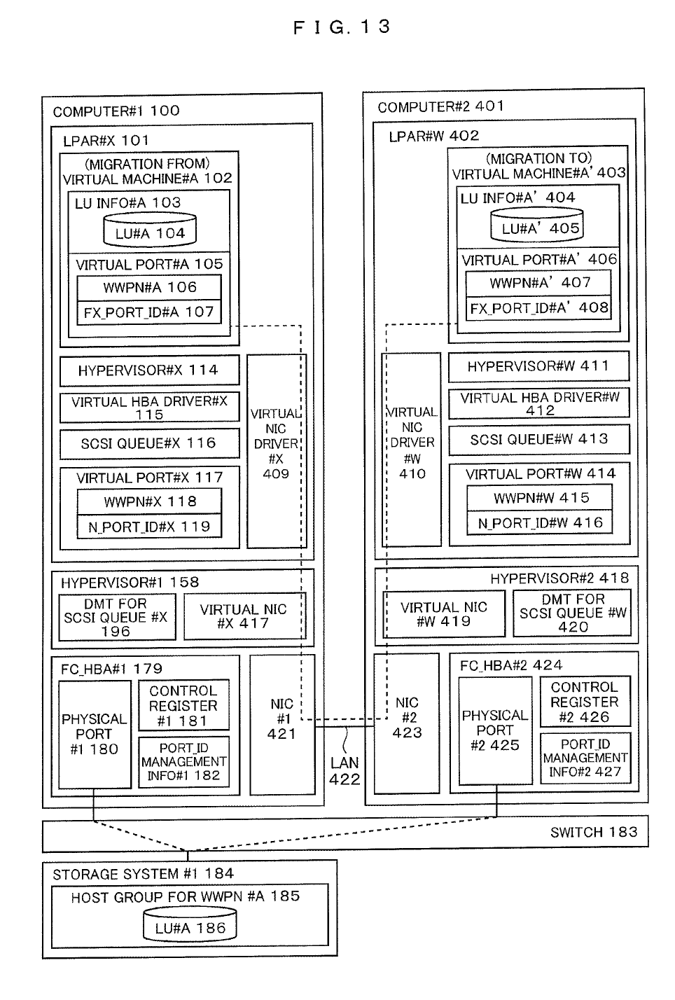

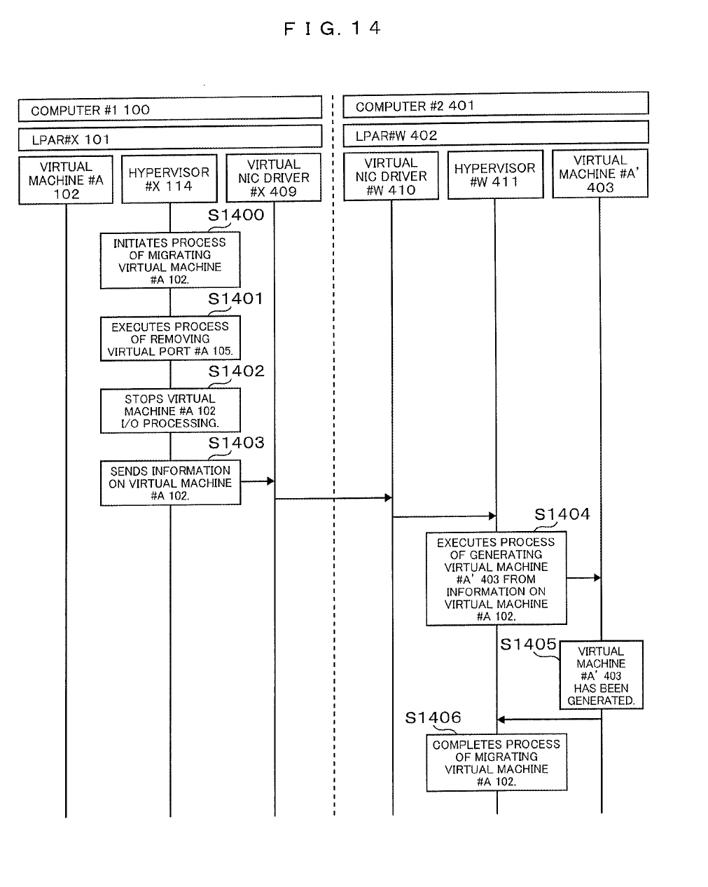

FIG. 13 is a diagram depicting a configuration of a computer system which carries out migration. By way of example, a system configuration, when migrating a virtual machine #A 102 from a computer #1 100 to a computer #2 401, is described.

The computer #1 100 and the computer #2 401 are connected; i.e., NIC (Network Interface Card) #1 421 of the computer #1 100 and NIC #2 423 of the computer #2 401 are connected via LAN (Local Area Network) 422. In the hypervisor #1 158 of the computer #1 100 and the hypervisor #2 of the computer #2 401, a virtual NIC #X 417 and a virtual NIC #W 419 reside, respectively. After migration is carried out, a virtual machine corresponding to the virtual machine #A 102 migrated from the computer #1 100 to the computer #2 401 is referred to as a virtual machine #A′ 403.

The physical port #1 180 of the FC-HBA #1 179 in the computer #1 100 and the physical port #2 425 of the FC-HBA #2 424 in the computer #2 401 are both connected to the storage system #1 184 via the switch 183. Other components of the computer #1 100 and the computer #2 401 are substantially identical, as depicted in FIG. 13.

FIG. 14 illustrates a sequence of a process of migrating a virtual machine between computers. The hypervisor #X 114 initiates the process of migrating the virtual machine #A 102 (S1400). The hypervisor #X 114 executes a process of removing the virtual port #A 105 (S1401). The process of removing a virtual port is described by the steps S1200 to S1210 in FIG. 12 and, therefore, its description is dispensed with.

The hypervisor #X 114 stops I/O processing of the virtual machine #A 102 (S1402). The hypervisor #X 114 sends information on the virtual machine #A 102 to a hypervisor #W 411 (S1403). Here, the information on the virtual machine #A 102 to be sent is data relevant to the virtual machine #A 102, stored in the main memory 200 of the hypervisor #X 114 and WWPN #A and FX_PORT_ID #A are included in that data.

The hypervisor #W 411 executes a process of generating a virtual machine #A′ 403 from the information on the virtual machine #A 102 received from the hypervisor #X 114 (S1404). The process of generating a virtual machine is described by the steps S900 to S914 in FIG. 9 and, therefore, its description is dispensed with.

The virtual machine #A′ 403 has been generated (S1405). The hypervisor #W 411 completes the process of migrating the virtual machine #A 102 (S1406).

The destination to migrate (move) the virtual machine #A 102 is not only another computer like the computer #2 401; the virtual machine may be migrated (moved) to a LPAR #Y 120 or LPAR #Z 139 within the same computer #1 100. The process of migrating the virtual machine in the latter case is the same as described above and, therefore, its description is dispensed with.

According to the present embodiment, a hypervisor included in an LPAR is allowed to make use of an NPIV function of an FC-HBA and it is enabled to assign a virtual port to a virtual machine running on the hypervisor included in the LPAR. Therefore, using WWPN of a virtual port assigned to a virtual machine, it is possible to implement storage system's LU assignment and zoning in an FC Switch and it would become easy to distribute resources on a per virtual machine basis. It is also possible to use the NPIV function on 256 or more virtual machines without depending on a limitation that a maximum number of PORT IDs supported by the FC Switch is 255.

### REFERENCE SIGNS LIST

100: Computer #1, 101: LPAR #X, 102: Virtual machine #A, 103: LU information #A, 104: LU #A, 105: Virtual port #A, 106: WWPN #A, 107: FX_PORT_ID #A, 114: Hypervisor #X, 115: Virtual HBA driver #X, 116: SCSI queue #X, 117: Virtual port #X, 118: WWPN #X, 119: N_PORT_ID #X, 120: LPAR #Y, 139: LPAR #Z, 158: Hypervisor #1, 160: DMT for invoke queue #A, 163: DMT for response queue #A, 179: FC-HBA #1, 180: Physical port #1, 181: Control register #1, 182: Port_ID management information #1, 183: Switch, 184: Storage system #1, 185: Host group for WWPN #A, 186: LU #A, 200: Main memory, 201: Memory access control chip, 202: Processor #1, and 203: Processor #2.

1. An I/O control method for a computer comprising hardware resources which include processors, a physical memory, and an I/O adapter; and a first hypervisor which logically divides the hardware resources into one or more logical partitions, wherein the computer connects with a storage system, the I/O control method wherein:
when the I/O adapter receives an instruction to issue an input/output command to a logical unit included in the storage system from a first virtual machine comprised in a first logical partition,
the I/O adapter sends an input/output command including first identifying information which identifies a first virtual port comprised in the first virtual machine to the storage system.

2. The I/O control method according to claim 1, wherein:
the I/O adapter correlates and manages the first identifying information which identifies the first virtual port and second identifying information which identifies the first logical partition as management information,
upon receiving an I/O response from the storage system, if the first identifying information which identifies the first virtual port is included in the received I/O response, the I/O adapter refers to the management information and retrieves the second identifying information correlated to the first identifying information, and
the I/O adapter sends the first hypervisor a request of I/O response interrupt to the first logical partition identified by the retrieved second identifying information.

3. The I/O control method according to claim 2, wherein:
the first hypervisor generates a second virtual port which corresponds to a physical port included in the I/O adapter and assigns the second virtual port to the first logical partition,
a second hypervisor included in the first logical partition generates the first virtual machine based on first hardware resources assigned to the first logical partition,
the second hypervisor generates the first virtual port which corresponds to the second virtual port assigned to the first logical partition and assigns the first virtual port to the first virtual machine, and
the first virtual machine issues an input/output command to the logical unit of the storage system from the first virtual port.

4. The I/O control method according to claim 3, wherein:
the second hypervisor sends the issued input/output command to a virtual driver included in the first logical partition,
the virtual driver stores transmission data included in the received input/output command into a physical memory and acquires a first address in the physical memory at which the transmission data has been stored,
based on the received input/output command, the virtual driver stores identifying information which identifies a port included in the storage system, the first identifying information which identifies the first virtual port, and the acquired first address in the physical memory into an invoke queue included in the first logical partition, and
the virtual driver instructs the first hypervisor to issue the input/output command.

5. The I/O control method according to claim 4, wherein:
a virtual address of the invoke queue is included in an instruction to issue the input/output command,
the first hypervisor instructed to issue the input/output command refers to address mapping information included in the first hypervisor and converts the virtual address of the invoke queue included in the instruction to issue the input/output command to a physical address of the invoke queue,
the first hypervisor sends the instruction to issue the input/output command including the physical address of the invoke queue to the I/O adapter,
the I/O adapter receives the instruction to issue the input/output command, refers to the invoke queue based on the physical address of the invoke queue included in the input/output command, and retrieves identifying information which identifies a port included in the storage system, the first identifying information which identifies the first virtual port, and the first address in the physical memory,
the I/O adapter retrieves the transmission data stored in the physical memory at the first address retrieved, and
the I/O adapter sends an input/output command including the transmission data, identifying information which identifies a port included in the storage system, and the first identifying information which identifies the first virtual port to the storage system.

6. The I/O control method according to claim 2, wherein:
the first identifying information which identifies the first virtual port and input/output result are included in the I/O response,
the I/O adapter stores the input/output result included in the I/O response into the physical memory and acquires a second address in the physical memory at which the input/output result has been stored, and
based on the I/O response, the I/O adapter stores the first identifying information which identifies the first virtual port and the acquired second address into a response queue included in the first logical partition.

7. The I/O control method according to claim 6, wherein:
a physical address of the response queue is included in the request of I/O response interrupt,
the first hypervisor receives the request of I/O response interrupt, refers to address mapping information included in the first hypervisor, and converts the physical address of the response queue to a virtual address of the response queue,
the first hypervisor executes an I/O response interrupt including the virtual address of the response queue to the virtual driver included in the first logical partition,
the virtual driver receives the I/O response interrupt, refers to the response queue based on the virtual address of the response queue included in the I/O response interrupt, and retrieves the first identifying information which identifies the first virtual port and the second address in the physical memory,
the virtual driver retrieves the input/output result stored in the physical memory at the second address retrieved, and
the virtual driver sends an I/O response including the input/output result and the first identifying information which identifies the first virtual port to the first virtual machine.

8. The I/O control method according to claim 2, wherein:
when migrating the first virtual machine to any other logical partition within the computer or any other computer, the I/O control method comprises a step of sending the first identifying information which identifies the first virtual port to the any other logical partition or the any other computer which is the destination to migrate.

9. A computer comprising:
hardware resources which comprise processors, a physical memory, and an I/O adapter;
a first hypervisor which logically divides the hardware resources into one or more logical partitions; and
an I/O adapter which connects with the storage system and, upon receiving an instruction to issue an input/output command to a logical unit included in the storage system from a first virtual machine comprised in a first logical partition, sends an input/output command including first identifying information which identifies a first virtual port comprised in the first virtual machine to the storage system.

10. The computer according to claim 9, wherein:
the I/O adapter includes a set of management information in which it correlates and manages the first identifying information which identifies the first virtual port and second identifying information which identifies the first logical partition,
upon receiving an I/O response from the storage system, if the first identifying information which identifies the first virtual port is included in the received I/O response, the I/O adapter refers to the management information and retrieves the second identifying information correlated to the first identifying information, and
the I/O adapter sends the first hypervisor a request of I/O response interrupt to the first logical partition identified by the retrieved second identifying information.

11. The computer according to claim 10, wherein:
the first hypervisor generates a second virtual port which corresponds to a physical port included in the I/O adapter and assigns the second virtual port to the first logical partition,
the first logical partition includes a second hypervisor,
the second hypervisor generates the first virtual machine based on first hardware resources assigned to the first logical partition,
the second hypervisor generates the first virtual port which corresponds to the second virtual port assigned to the first logical partition and assigns the first virtual port to the first virtual machine, and
the first virtual machine issues an input/output command to the logical unit of the storage system from the first virtual port.

12. The computer according to claim 10, wherein:
the first identifying information which identifies the first virtual port and input/output result are included in the I/O response,
the first logical partition includes a response queue,
the I/O adapter stores the input/output result included in the I/O response into the physical memory and acquires a second address in the physical memory at which the input/output result has been stored, and
based on the I/O response, the I/O adapter stores the first identifying information which identifies the first virtual port and the acquired second address into the response queue.

13. The computer according to claim 12, wherein:
a physical address of the response queue is included in the request of I/O response interrupt,
the first hypervisor receives the request of I/O response interrupt, refers to address mapping information included in the first hypervisor, and converts the physical address of the response queue to a virtual address of the response queue,
the first hypervisor executes an I/O response interrupt including the virtual address of the response queue to the virtual driver included in the first logical partition,
the virtual driver receives the I/O response interrupt, refers to the response queue based on the virtual address of the response queue included in the I/O response interrupt, and retrieves the first identifying information which identifies the first virtual port and the second address in the physical memory,
the virtual driver retrieves the input/output result stored in the physical memory at the second address retrieved, and
the virtual driver sends an I/O response including the input/output result and the first identifying information which identifies the first virtual port to the first virtual machine.

14. The computer according to claim 10, wherein:
the I/O adapter includes a physical port connecting with the storage system via a switch.
